(19) United States
(12) Patent Application Publication
(10) Pub. No.: US 2013/0297259 A1
(43) Pub. Date: Nov. 7, 2013

(54) SYSTEM AND METHOD OF APPROPRIATE SERVICES DETECTION FOR A SMART BUILDING

(71) Applicants: Shiao-Li TSAO, Taipei City (TW); Ming-Chun LIN, Keelung City (TW); Yung-Chi CHEN, Taichung City (TW)

(72) Inventors: Shiao-Li TSAO, Taipei City (TW); Ming-Chun LIN, Keelung City (TW); Yung-Chi CHEN, Taichung City (TW)

(21) Appl. No.: 13/533,630

(22) Filed: Jun. 26, 2012

(30) Foreign Application Priority Data
May 4, 2012 (TW) 101115932

(51) Int. Cl. G06F 19/00

(52) U.S. Cl. 702/188

(57) ABSTRACT

A system and method of appropriate services detection for a smart building are disclosed in the present invention. The invention may select appropriate services for a house or a building. After a user lives in a smart building with the system of the present invention for a period of time, the system uses the service gateway to collect and analyze environment information and appliance information so as to find relationship within appliances, sensors and actuators. Thus the cloud service platform selects appropriate services for the building to avoid downloading or installing an inappropriate service by a user. Further the cloud service platform may suggest a user buying additional equipment for matching the requirement of a service. The system of the present invention may learn a relationship of devices; locate positions of devices; and automatically collect state data of appliances to identify the appliances.

### BACKGROUND OF THE INVENTION

(a) Field of the Invention

The invention relates to a system and a method, particularly to a system and a method of appropriate services detection for a smart building.

(b) Description of the Related Art

Recently, smart meters are highly recommended by officials because not only the smart meters have the advantages of remote meter reading and assisting in power distribution but also users can analyze their own power usage behavior to change such behavior for power saving. A smart meter including a function of recognizing appliance states can identify the electrical load from detected power information and record usage time under different states of each appliance (for example, an electric fan at 1:00 p.m. switched from one speed to another) and power consumption of the appliance. Therefore, the smart meter can detect power consumption of an appliance.

Customized services can be designed or provided by combining the data of appliances from the smart meter, environment data from sensors and the control capability of actuators. For example, the services includes scene lighting, detecting aging of household appliances, estimating the efficiency of power saving appliances, detecting locations of household appliances, turning off power of a socket if detecting any static power consumption of the socket, and so forth. A network gateway or a set-top box can be used as a service gateway to execute the service on the service gateway.

However, how to learn which service is suited to which power usage environment or how to find out the appropriate service in the building to filter out unnecessary services is an urgently to-be-solved problem.

### BRIEF SUMMARY OF THE INVENTION

One object of the invention is to provide a method which may select appropriate services for a house or a building for a user or users. A service gateway is used to collect data from appliances, sensors, actuators and the correlation between these devices is analyzed to filter out the services unable to be executed in the environment or to recommend a user additional device(s) to be purchased in order to execute a recommended service. At the same time, the correlation between these devices may assist a user in automatically locating a device in the house and automatically collecting appliance recognition data.

In the prior art, usually a sensing and actuating network for power saving, quickly accessing sensing data and analyzing the meaning of the sensing data on an embedded platform is discussed. However, either the construction of the correlation among the appliances, sensors and actuators or the construction of services is seldom considered. A variety of appliances together with sensors and actuators may provide various services. The system of the present invention finds out a relationship map between the devices (including appliances, sensors and actuators) through an algorithm of analyzing correlations among the devices in the house. Thus, a service or service suitable for the environment can be selected among cloud services without providing inexecutable services for the environment. The system may also list additional required devices of a service desired by a user. At the same time, the relationship map may be used to assist a user in automatically locating a device in the house and automatically collecting appliance recognition data so as to increase usability of the system according to the invention.

One embodiment of the invention provides a system of appropriate services detection for a smart building. The system includes devices including at least one smart meter, zero˜several actuators, zero˜several appliances, zero˜several sensors and at least one user interface, a service gateway, and a cloud service platform. The smart meter analyzes variation of total load of a building to detect state data of the appliances. The actuators are used to control operations of the appliances of a building. The sensors are used to collect environmental data in a building. The user interface, such as PC, smart phone or pad, is used to operate the services. The service gateway receives a plurality of appliance state data of appliances and a plurality of sensing data, data of actuators to generate a correlation data between the devices and execute the service bundle downloaded by a user. The cloud service platform includes a plurality of services and provides a corresponding service according to the correlation data among the devices.

Another embodiment of the invention provides a method of appropriate services detection for a smart building. The method includes: in a period of time, detecting an interaction relationship of devices in the building to generate device combinations; and selecting at least one device to which a correlation value of one device combination higher than an interactive threshold and providing a corresponding service bundle according to the device combination.

Another embodiment of the invention provides a method of appropriate services detection for a smart building. The method includes: searching for operation relationships of a plurality of devices according to a history record of device state of the building to generate a device correlation data wherein the devices includes at least one sensor, at least one actuator and at least one appliance; when occurrence times of one combination of device states in a preset period is larger than a threshold, determining that the combination is correlated within the time to generate a correlation data; and filtering out inappropriate services and providing appropriate services to users in the building, according to the correlation data.

The system and method of appropriate services detection for a smart building according to the invention use the service gateway to collect data such as sensing data, operating states of actuators and when the state of the appliance is changed, etc. to acquire a correlation data among devices to achieve the purpose of selecting appropriate services for a user in the building.

Other objects and advantages of the invention can be better understood from the technical characteristics disclosed by the invention. In order to clarify the above mentioned and other objects and advantages of the invention, examples accompanying with figures are provided and described in details in the following.

### BRIEF DESCRIPTION OF THE DRAWINGS

FIG. 1 shows a schematic diagram illustrating a system of appropriate services detection for a smart building according to one embodiment of the invention.

FIG. 2A shows a timing diagram of appliance state data and sensor state data flow in a preset period according to one embodiment of the invention.

FIG. 2B shows a schematic diagram illustrating the sequence form by the state data shown in FIG. 2A.

FIG. 3A shows a schematic diagram illustrating an example that the cloud service platform analyzes the support data and confidence data.

FIG. 3B shows a schematic diagram illustrating another example that the cloud service platform analyzes the support data and confidence data.

FIG. 4 shows a schematic diagram illustrating services according to one embodiment of the invention.

FIG. 5 shows a flow chart illustrating a method of appropriate services detection for a smart building according to one embodiment of the invention.

FIG. 6 shows a flow chart illustrating a method of appropriate services detection for a smart building according to another embodiment of the invention.

### DETAILED DESCRIPTION OF THE INVENTION

One embodiment of the system of appropriate services detection for a smart building of the invention includes a smart meter having a function of recognizing appliance states, sensors, actuators, a service gateway and a cloud service platform.

The smart meter having a function of recognizing the appliance state according to an embodiment of the invention may be a non-invasive smart meter platform designed by the inventor. Please refer to TW100113237 and TW100142497. The sensors may include temperature, humidity, and brightness sensors, etc. The actuators may include controllers, sockets, switches, dimmer, IR transceivers, etc. A server or a computer may provide functions as the service gateway and the cloud service platform.

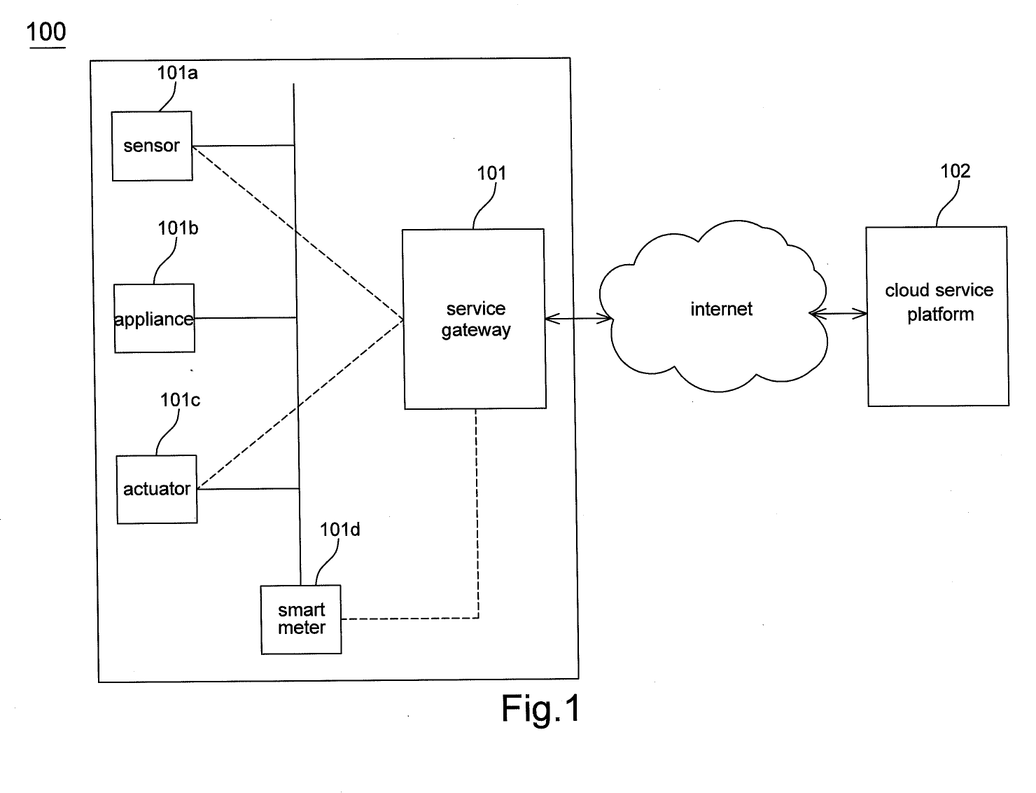

FIG. 1 shows a schematic diagram illustrating a system 100 of appropriate services detection for a smart building according to an embodiment of the invention. The system 100 of appropriate services detection for a smart building includes a service gateway 101 and a cloud service platform 102. The service gateway 101 receives a plurality appliance state data of appliances and sensor state data of zero˜several sensors in the building. The service gateway 101 may use a wired or wireless network to receive data. In an embodiment, the solid line in the figure represents a power line and the dashed line represents a wired or wireless network connection.

In an embodiment, the building may be set one device selected from a sensor 101a, an appliance 101b, an actuator 101c and a smart meter 101d or combination thereof. Any number of sensors 101a, appliances 101b, actuators 101c and smart meters 101d may be set according to user's needs.

The sensor state data may be generated by at least one sensor 101a based on sensing physical phenomena, such as temperature, brightness, humidity, ultraviolet radiation, etc. The above physical phenomena are examples only and the invention is not limited to these examples.

The appliance state data may be generated by at least one actuator 101c or a smart meter 101d.

The smart meter 101d may be a meter having a function of recognizing an appliance. The smart meter 101d detects variation of power data of a building. The smart meter 101d may be coupled to one device selected from the sensor 101a, the appliance 101b and the actuator 101c or combination thereof through a power line. The power data may be analyzed by an appliance recognition algorithm and the appliance state data such as a power usage state and an operating state of the sensor 101a, the appliance 101b and the actuator 101c may be transmitted to the service gateway 101 through a network such as Ethernet or WiFi (Wireless Fidelity). In another embodiment, the smart meter 101d may be a smart meter with NILM (Nonintrusive load monitoring) functions.

The cloud service platform 102 receives and analyzes the appliance state data and the sensor state data through a network to generate a device correlation data.

Further the system 100 of appropriate services detection for a smart building generates a plurality of services for a user according to the device correlation data.

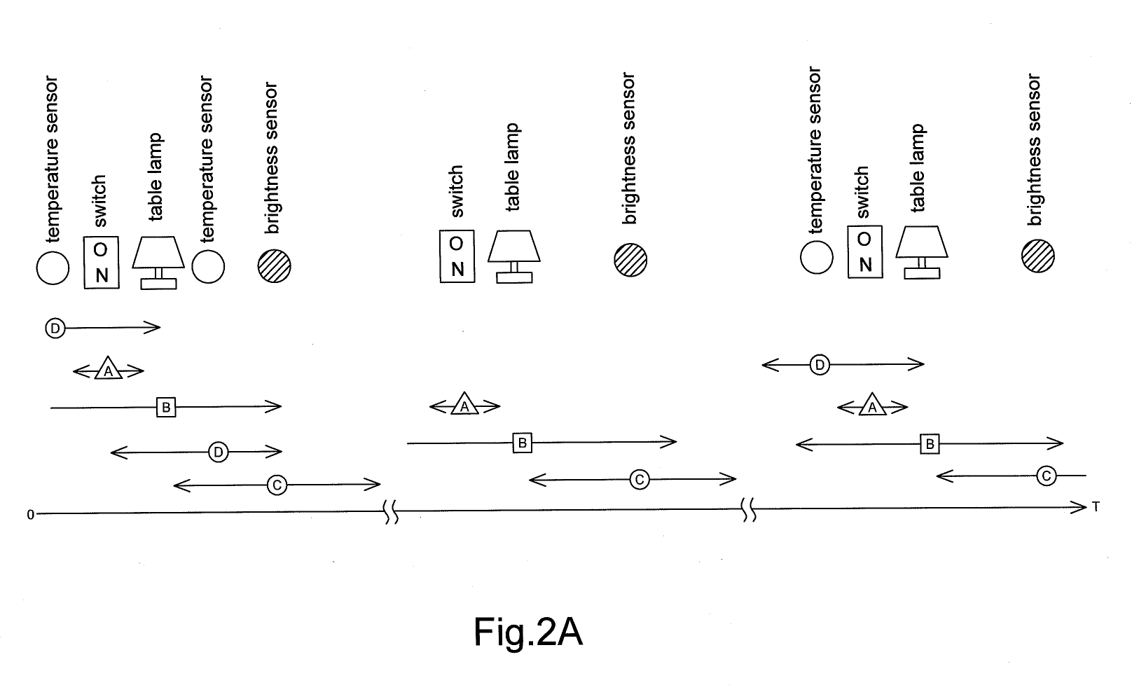

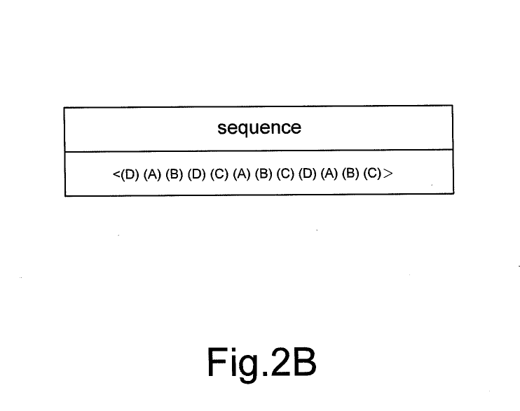

For example, the cloud service platform 102 sets the appliance state data and sensor state data received within a preset period to be a sequence. As shown in FIG. 2A, from time 0˜T, the sensor state data D is the variation sensed by a temperature sensor, the switch data A is the turn-on signal of the actuator, the appliance state data B is that the smart meter detects the table lamp being turned on and so forth. The sequence shown in FIG. 2B may be obtained as <(D)(A)(B)(D)(C)(A)(B)(C)(D)(A)(B)(C)>. The cloud service platform 102 analyzes the the sequence and generate the device correlation data.

In an embodiment, the device correlation data includes a support data. The support data may be the occurrence times of the same state data of a preset number in the sequence. For example, the sequence <(D)(A)(B)(D)(C)(A)(B)(C)(D)(A)(B)(C)> has a support data Support(<(A)(B)>)=3, that is, in the sequence <(D)(A)(B)(D)(C)(A)(B)(C)(D)(A)(B)(C)>, the occurrence times of the same state data (A)(B) of the preset number=2 are equal to 3 and thus the support data is set to 3.

In an embodiment, the device correlation data includes a confidence data. The confidence data may be the confidence level of the support data. For example, in the sequence <(D)(A)(B)(D)(C)(A)(B)(C)(D)(A)(B)(C)>, the confidence data of the state data <(A)(B)>is

$$Confidence ( < ( A ) ( B ) > ) = \frac{Support ( < ( A ) ( B ) > )}{Support ( < ( A ) > ) + Support ( < ( B ) > ) - Support ( < ( A ) ( B ) > )} = \frac{3}{3 + 3 - 3} = 1$$

and the confidence data is 100%. Support(<(A)>)=3 means that in the sequence <(D)(A)(B)(D)(C)(A)(B)(C)(D)(A)(B)(C)>, the state data (A) appears three times. Support(<(B)>)=3 means that in the sequence <(D)(A)(B)(D)(C)(A)(B)(C)(D)(A)(B)(C)>, the state data (B) appears three times. From the above description, the higher support or confidence data of the state data means that the correlation between the events related to the states A and B is higher. That is, the two events relate to each other. According to this relationship, the system of appropriate services detection for a smart building may provide appropriate services to a user. if the support data or confidence data of a combination of the state data is higher than a threshold, it may be considered that there is a certain degree of correlation between the related devices. At first, the cloud service platform 102 sets a support threshold for the support data and a confidence threshold for the confidence data and these values are used as a basis for correlation between states of devices. For example, it is assumed that the support threshold is 2 and the confidence threshold is 50%.

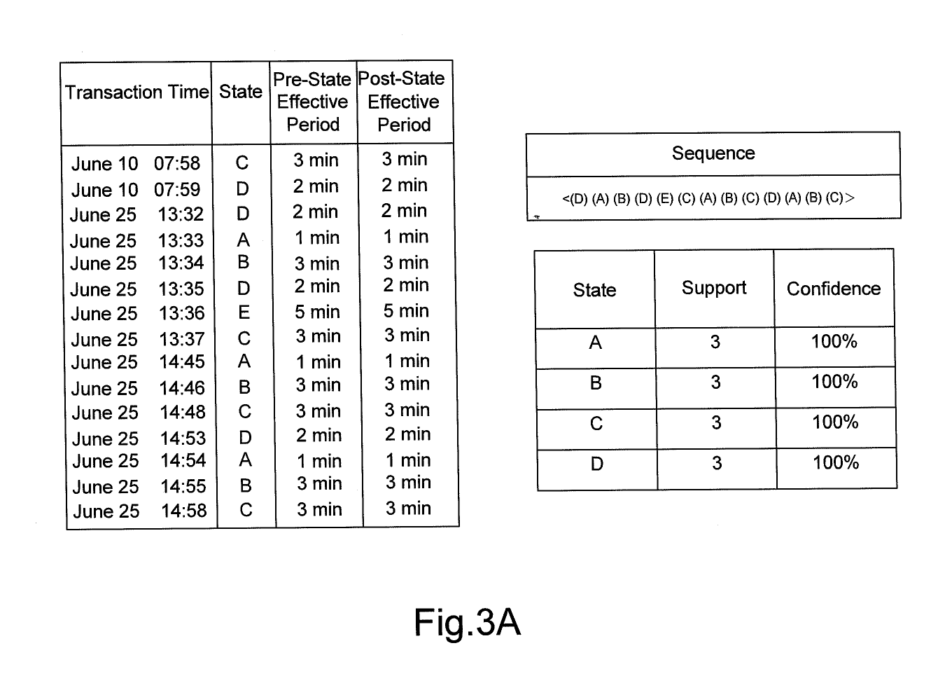

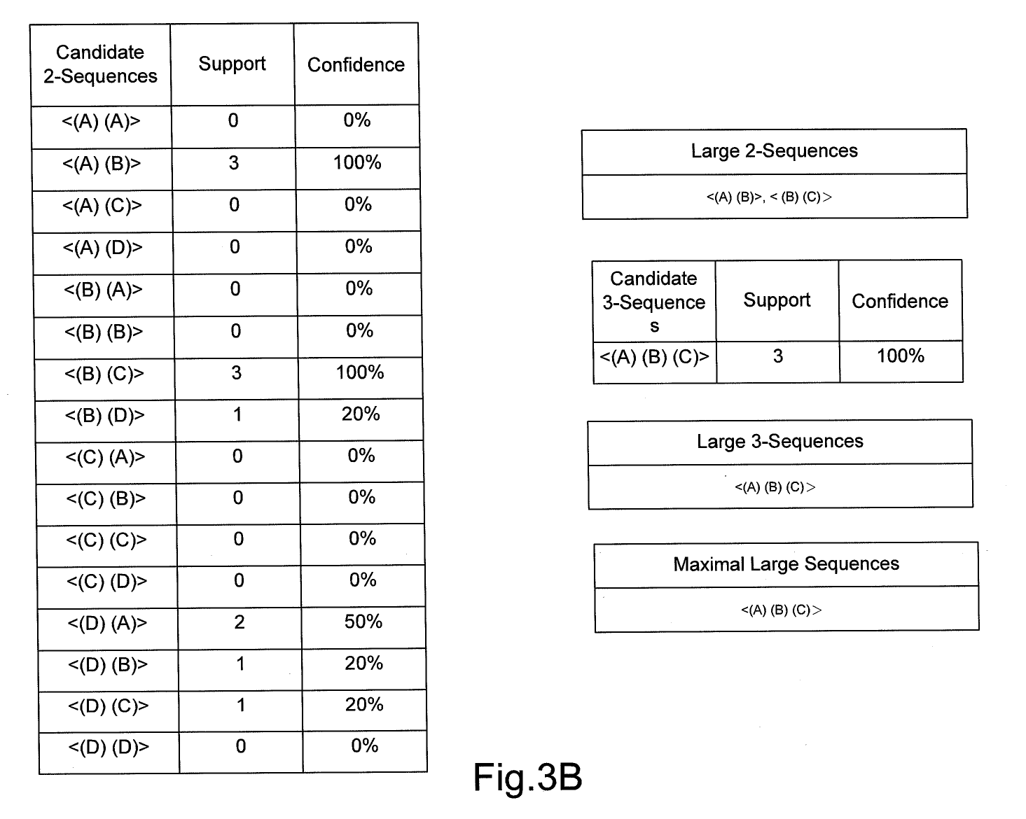

Taking FIGS. 3A and 3B as an example, at first an affecting time relationship of one operation of an appliance, a sensor, and an actuator is defined. For example, when an air conditioner is turned on, it takes some time to affect the temperature. Or, if the air conditioner is controlled by an actuator (such as a remote controller), the variation of the air state may be generated within some period of time. Therefore, the affecting time relationship of each operation of each appliance, sensor and actuator may be represented by a pre-state effective period and a post-state effective period to indicate the affecting time of an electrical or physical state. Please refer to FIG. 3A. Between 07:58 on June 10 and 14:58 on June 25, the cloud service platform 102 receives the state data C sensed by the brightness sensor where its pre-state effective period is 3 min and its post-state effective period is 3 min. The rest of data is also similar. Then, the received sequence is <(D)(A)(B)(D)(E)(C)(A)(B)(C)(D)(A)(B)(C)>. The pre-state effective period and the post-state effective period of each device represent the period of time that the device is under operation or senses effective data. For example, the state data C sensed by the brightness sensor means that the period of time sensing brightness is 6 min including the pre-state effective period (3 min) and the post-state effective period (3 min). The pre-state effective period and the post-state effective period of a state data overlapping with those of the other device mean that the two states affect to each other or may be correlated to each other and may be a reference data of correlation. It should be noted that the pre-state effective period and the post-state effective period of any device may include different length from each other. That is, the length of the front arrow may be different from that of the back arrow.

In an embodiment, the cloud service platform 102 uses the above equation to calculate the support data and the confidence data. For a state data, the support data of the state A, B, C and D are separately 3 and the confidence data are separately 100%. As shown on the Right-hand side of FIG. 3A, the support data of each state data is higher than the threshold (=2).

Next, two selected state data are used in calculation. The cloud service platform 102 selects any two state data in the sequence to analyze whether the support data of each state data is higher than the threshold (=2) or not so as to acquire more accurate correlation determination result. As shown in FIG. 3B, the support data and the confidence data of (<(A)(A)>) are both 0 and the support data of (<(A)(B)>) is 3 while the confidence data of (<(A)(B)>) is 100%. The support data and the confidence data of the rest of the state data are shown on the left-hand side of FIG. 3B. The two state data appearing more times and having the higher value of support data and confidence data are <(A)(B)> and <(B)(C)>. In the sequence, it is found that the occurrence times of the states A and B (or B and C) within the inter-affecting period of time are 3 and thus the support data of the state data is 3 and the confidence data is 100%. The support data and the confidence data are both higher than the thresholds, respectively, the state data A and B (or B and C) exist high correlation. By such a method, combinations of a plurality of state data are analyzed one by one to find out correlation of all state data and then operation correlation of the sensor 101a, appliance 101b and actuator 101c, etc., in a building may be found out statistically. Accordingly, the system 100 of appropriate services detection for a smart building may provide corresponding services.

In another embodiment, the cloud service platform 102 selects a plurality of state data, for example, three, to execute calculation. As shown on the bottom right-hand side of FIG. 3B, the sequence <(A)(B)(C)> having the highest occurrence times indicates that the three events have the highest correlation. The cloud service platform 102 learns more clearly that the three events <(A)(B)(C)> are highly correlated so as to obtain more accurate data correlation determination result.

It should be noted that the system 100 of appropriate services detection for a smart building learns the habit of a user of using appliances and the operation relationship between the appliances in a building so as to provide corresponding services. The services includes assisting in selecting correct services, positioning unknown appliances, detecting power consumption of unknown appliances, analyzing aging of appliances, etc.

Regarding selecting services, in an embodiment, the system 100 of appropriate services detection for a smart building filters out inappropriate services for the user in the building according to the correlation data and provides or recommends appropriate service bundles for the user and service profile of the user interface program to the service gateway 101. The user may select which service or user interface to be installed and the service gateway 101 may control operations of switches (actuators) through outputting a control signal by a controller via a radio-frequency or power line network according the executed service bundle so as to control appliances or browse power consumption to generate power saving suggestion, etc. For example, a user installs a scene lighting service bundle to use a brightness sensor to detect the environment brightness to control the brightness of the table lamp through a switch, such as a dimming actuator.

Regarding positioning unknown appliances, in an embodiment, the system 100 of appropriate services detection for a smart building may assist in positioning the location of an appliance and collecting state data of the appliance. After a user disposes sensors and actuators in a building, the position data of the appliances are provided to the system 100 of appropriate services detection for a smart building. In an embodiment, at first it is assumed that the brightness sensor is disposed in the living room and the system 100 does not know the position of the lamp. Then, if the appliance state is changed to result the total power load being changed, the smart meter 101d detects a lamp is turned on but the position of the lamp is unknown. The system 100 may use the device correlation data to find out that the appliance state is changed accompanying with the variation of the brightness sensor, and the lamp and the brightness sensor has correlation. Since the position of the brightness sensor is known, the system 100 recognizes the position of the lamp is in the living room. By such a method, the effect of positioning appliances can be achieved. It should be noted that in an embodiment the smart meter 101d may be omitted. The system of appropriate services detection for a smart building only needs the device correlation data to know the brightness variation and the position data of the brightness sensor so as to determine brightness variation and the position of a lamp.

A programmer may write a service profile or have a compiler automatically analyze the application program interface (API) to automatically generate the service profile to categorize services according to the required devices for the system 100 of appropriate services detection for a smart building. For example, the description may be which type of appliance, which type of sensor, and/or which type of actuator is required. The description may be a specific appliance, sensor, or actuator and can be one type of any appliance, sensor, or actuator. After the profile of device requirements for the services of each cloud is obtained, the service gateway 101 may compare the relationship of devices in a house or building with the relationship between the cloud services and the devices and then recommend a user to download if the requirement is matched. Besides, the service gateway 101 may inform a user which additional device is needed for a certain new service.

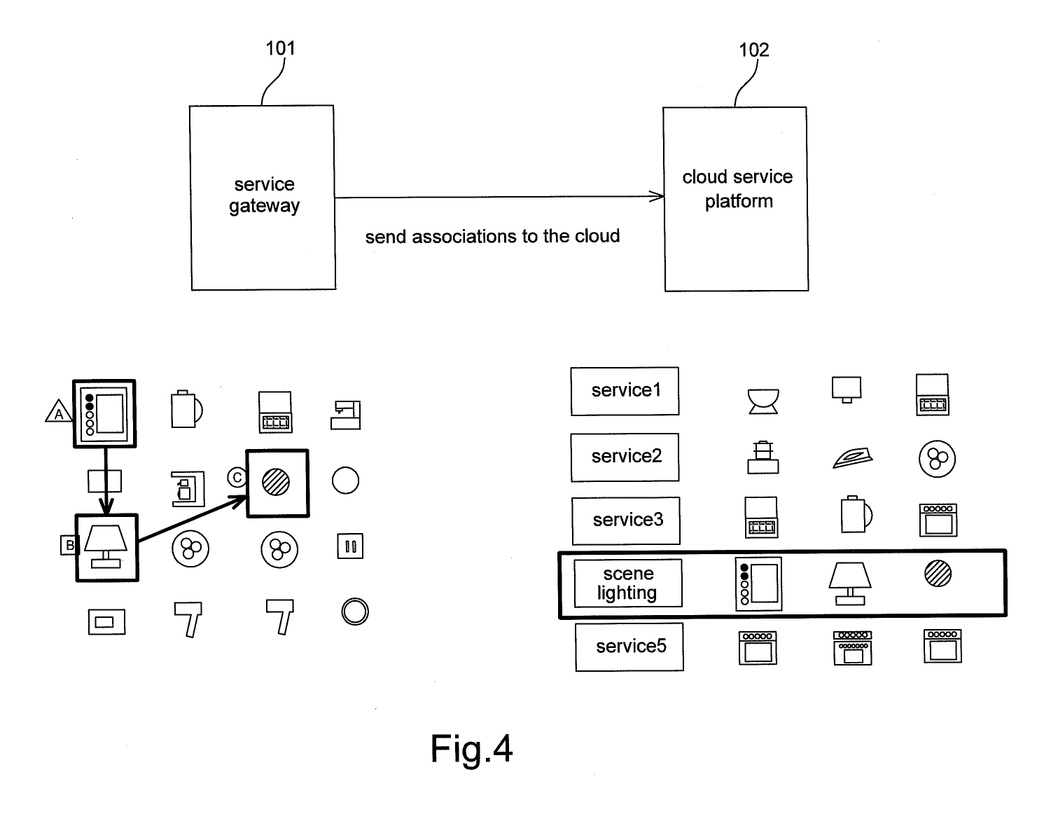

In an embodiment, as shown on the right-hand side of FIG. 4, the service gateway 101 includes services such as a scene lighting service, etc. The profile of requirements for the scene lighting service includes having a brightness sensor A, a dimmable lamp B, and a dimmer C in the house. As shown on the left-hand side of FIG. 4, if there are the above three devices in the house, the service gateway 101 may download the service bundle from the application download server of the cloud service platform 102. The scene lighting service is shown in the circled area by dark solid line in the figure.

In another embodiment, the service gateway 101 include a service analyzing aging of appliances. The service needs a smart meter having a function of recognizing appliances or needs some sockets having a function of analyzing power consumption of appliances. Through the description of the profile, the requirements of the service are found to be (a) a smart meter having a function of recognizing appliances or (b) at least one socket having a function of analyzing power consumption of appliances in a house. If the service gateway 101 detects any one device of the above mentioned two devices, the service is suitable to the house of the user.

It should be noted that the system and method of appropriate services detection for a smart building according to embodiments of the invention provide services either using a loose method or a strict method or combination thereof. The way of using a loose method has a corresponding service profile only describing some types of devices (loose limitations). For example, as long as there is any electric fan, the requirement for the service is fulfilled. The strict method is to design the service only suitable for one specific type of appliance, such as 14-inch electric fan of a brand (strict limitation). Thus, the service profile should include the required type of appliances.

Regarding detecting power consumption of unknown appliances, in an embodiment, when a user adds a new appliance in a building, since the system 100 of appropriate services detection for a smart building has no loading characteristic data of the unrecognized appliance, the smart meter 101d detects there is appliance state change but does not know which type of appliance is added. However, each operating command of the actuator 101c represents the control of a specific type of appliance. For example, controlling the dimming actuator represents the brightness increase or decrease of the lamp. The system 100 of appropriate services detection for a smart building realizes that the unknown appliance by the correlation.

It should be noted that the above positioning and determination of the actuator and the lamp is only an example and the invention is not limited to this example. The system 100 of appropriate services detection for a smart building may position and determine any current or future to-be-developed actuator and appliance.

The system 100 of appropriate services detection for a smart building may categorize services according to required devices. For example, which type of appliance, sensor, and actuator is required and the part of description may be a specific appliance, sensor, or actuator, and may be any type of appliance, sensor, and actuator in one category. After the profile of device requirements for the services of each cloud is obtained, the service gateway 101 may compare the relationship of appliances in a building with the relationship between the cloud services and the devices and then recommend a user to download if the requirement is matched. Besides, the service gateway 101 can inform a user which additional device is needed for a certain new service.

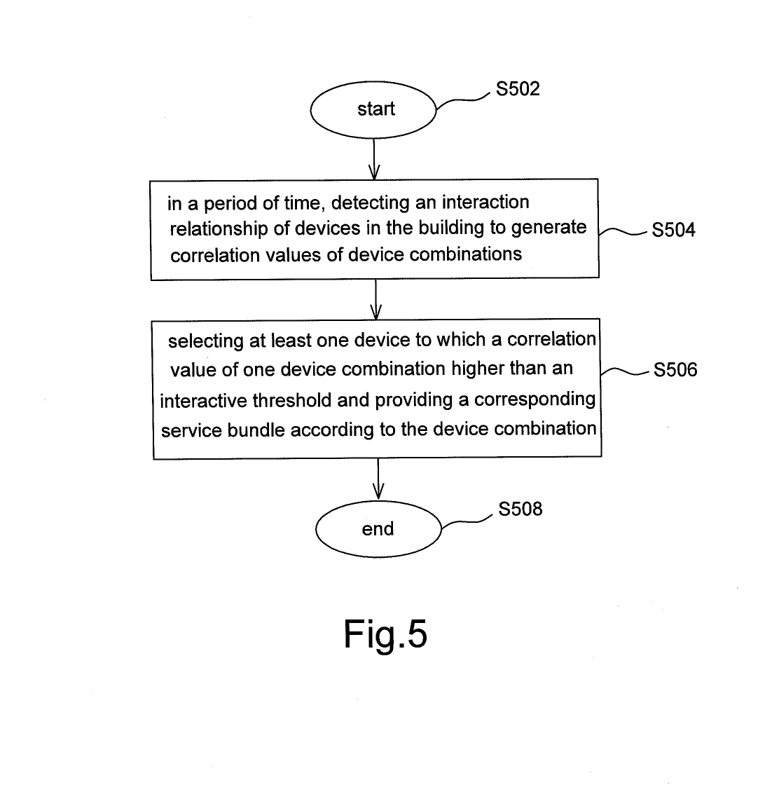

FIG. 5 shows a flow chart illustrating a method of appropriate services detection for a smart building according to one embodiment of the invention. The method comprises the following steps:

Step S502: start:

Step S504: in a period of time, detecting an interaction relationship of devices in the building to generate correlation values of device combinations;

Step S506: selecting at least one device to which a correlation value of one device combination higher than an interactive threshold and providing a corresponding service bundle according to the device combination;

Step S508: end.

It should be noted that the device can be selected from the group consisting of appliance, sensor and actuator or combination thereof.

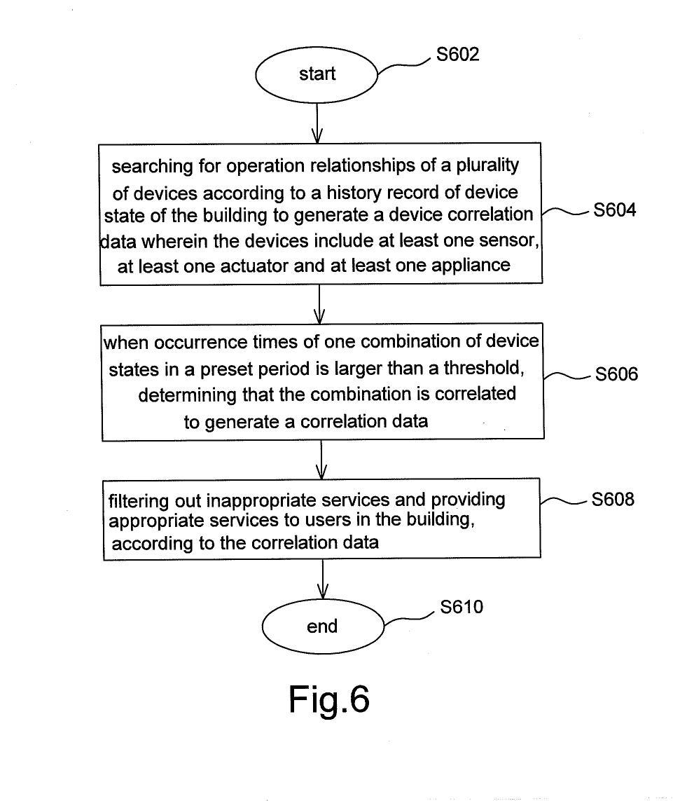

FIG. 6 shows a flow chart illustrating a method of appropriate services detection for a smart building according to another embodiment of the invention. The method comprises the following steps:

Step S602: start:

Step S604: searching for operation relationships of a plurality of devices according to a history record of device state of the building to generate a device correlation data wherein the devices include at least one sensor, at least one actuator and at least one appliance;

Step S606: when occurrence times of one combination of device states in a preset period is larger than a threshold, determining that the combination is correlated to generate a correlation data;

Step S608: filtering out inappropriate services and providing appropriate services to users in the building, according to the correlation data;

Step S610: end.

The system and method of appropriate services detection for a smart building according to the invention can download appropriate services for the appliances according to the appliances in a building to have a user directly install without installing inappropriate services to achieve the purpose of customized servicing a client and selecting appropriate services for the client.

Although the present invention has been fully described by the above embodiments, the embodiments should not constitute the limitation of the scope of the invention. Various modifications or changes can be made by those who are skilled in the art without deviating from the spirit of the invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. A system of appropriate services detection for a smart building, the system comprising:
a service gateway, receiving a plurality of appliance state data of appliances and a plurality of sensor state data of sensors in the building; and
a cloud service platform, receiving and analyzing the appliance state data and the sensor state data through a network so as to generate a device correlation data;
wherein the system generates services for a user according to the device correlation data.

2. The system according to claim 1, wherein the appliance state data is generated by at least an actuator or a smart meter.

3. The system according to claim 2, wherein the smart meter is a smart meter with NILM (Nonintrusive load monitoring) functions.

4. The system according to claim 1, wherein the appliance state data and the sensor state data are formed into a sequence based on being generated in a preset period by specific order.

5. The system according to claim 4, wherein the device correlation data comprises a support data and the support data is generated by the cloud service platform through selecting a preset number of same state data in the sequence and analyzing occurrence times of the same state data of the preset number.

6. The system according to claim 5, wherein the appliance correlation data comprises a confidence data and the cloud service platform subtracts the support data from sum of the occurrence times of the same state data of the preset number to acquire a calculation result and generates the confidence data according to a ratio of the calculation result to the support data.

7. The system according to claim 6, wherein, when the support data and the confidence data are higher than a threshold, there is a correlation between the devices that the same state data corresponds.

8. The system according to claim 1, wherein the appliance state data and the sensor state data comprise a pre-state effective period and a post-state effective period and the pre-state effective period represents a period of time that the state data corresponding to an appliance or a sensor is effective.

9. The system according to claim 8, wherein two state data are correlated if the pre-state effective period or the post-state effective period of one appliance state data or sensor state data is overlapped with that of the other appliance state data or sensor state data.

10. A method of appropriate services detection for a smart building, the method comprising:
in a period of time, detecting an interaction relationship of devices in the building to generate correlation values of device combinations; and
selecting at least one device to which a correlation value of one device combination higher than an interactive threshold and providing a corresponding service bundle according to the device combination.

11. The method according to claim 10, wherein the device combination to which the service bundle corresponds comprises one of two methods including one using loose limitations and the other one using strict limitations.

12. A method of appropriate services detection for a smart building, the method comprising:
searching for operation relationships of a plurality of devices according to a history record of device state of the building to generate a device correlation data wherein the devices comprise at least one sensor, at least one actuator and at least one appliance;
when occurrence times of one combination of device states in a preset period is larger than a threshold, determining that the combination is correlated within the time to generate a correlation data; and
filtering out inappropriate services and providing appropriate services to users in the building, according to the correlation data.
